(19) United States
(12) Patent Application Publication
(10) Pub. No.: US 2015/0120147 A1
(43) Pub. Date: Apr. 30, 2015

(54) VEHICLE COLLISION DETERMINATION APPARATUS

(71) Applicant: HONDA MOTOR CO., LTD., Tokyo (JP)

(72) Inventor: Kenyu Okamura, Wako-shi (JP)

(21) Appl. No.: 14/524,091

(22) Filed: Oct. 27, 2014

(30) Foreign Application Priority Data
Oct. 29, 2013 (JP) 2013-224616

(51) Int. Cl. B60R 21/0132

(52) U.S. Cl. CPC B60R 21/0132
USPC 701/45; 701/1

(57) ABSTRACT

A vehicle collision determination apparatus includes a sensor disposed on a mounting surface in a cabin of a vehicle, and a determining part that determines whether or not a collision of the vehicle has occurred, on the basis of an output from the sensor. The output from the sensor includes first acceleration in a direction vertical to the mounting surface, and when energy based on an amplitude of the first acceleration or a physical quantity correlating to the energy exceeds a threshold, the determining part determines that the collision has occurred. The output of the sensor further includes second acceleration in a rearward direction of the vehicle, and when a value, which is determined by the energy or the physical quantity correlating to the energy and an integrated value of the second acceleration, exceeds the threshold, the determining part determines that the collision has occurred.

### FIELD OF THE INVENTION

The present invention relates to a vehicle collision determination apparatus configured to determine a collision of a vehicle using an output from a sensor indicative of acceleration in a vertical or up-down direction of the vehicle.

### BACKGROUND OF THE INVENTION

Japanese Patent Application Laid-open Publication (JP-A) No. 07-165004 discloses an example of vehicle collision determination apparatuses which is capable of determining a collision of a vehicle using not only an output from an acceleration sensor indicative of acceleration in a longitudinal or front-rear direction of the vehicle, but also outputs from the acceleration sensor indicative of acceleration in a lateral or left-right direction of the vehicle and acceleration in a vertical or up-down direction of the vehicle. In determining the occurrence of a vehicle collision, the disclosed vehicle collision determination apparatus uses a two-dimensional collision determination map with two axes respectively representing the impact force and the velocity change amount that are determined based on the output, in the vehicle longitudinal direction, of the acceleration sensor. The collision determination map includes a determination curve which is a threshold for discriminating between a collision region in which deployment of an airbag is required, and a non-collision region in which deployment of the airbag is not required. When a coordinate on the collision determination map, which is determined by an impact force and a velocity change amount obtained based on the output, in the vehicle longitudinal direction, of the acceleration sensor at the time of a collision, is in the collision region, the vehicle collision determination apparatus determines that a collision requiring the deployment of an airbag has occurred.

The vehicle collision determination apparatus shown in JP 07-165004A determines as to whether an angle of the acceleration in the vehicle up-down direction relative to the vehicle traveling direction, which is determined by the output, in the vehicle up-down direction, from the acceleration sensor and the output, in the vehicle front-rear direction, from the acceleration sensor, is greater than a predetermined angle. When the angle of acceleration in the vehicle up-down direction is determined as being greater than the predetermined angle, it is determined that an under carriage collision has occurred where an occupant is subjected to a thrust-up impact caused due to sliding engagement of a bottom surface of the vehicle and a road surface. With this determination result, the vehicle collision determination apparatus displaces the determination curve in an upward direction toward the collision region to thereby prevent deployment of the airbag.

In the vehicle collision determined apparatus disclosed in JP 07-165004A, the output, in the vehicle up-down direction, from the acceleration sensor is used to determine the presence/absence of an impact acting in the up-down direction of the vehicle. More specifically, in making a determination about a frontal collision of the vehicle, the disclosed vehicle collision determination apparatus does not use the output from the acceleration sensor indicative of acceleration in the vehicle up-down direction, but does use the output from the acceleration sensor indicative of acceleration in the vehicle front-rear direction.

The vehicle collision determined apparatus disclosed in JP 07-165004A also uses the output from the acceleration sensor indicative of acceleration in the lateral or left-right direction of the vehicle. More specifically, the disclosed vehicle collision determination apparatus determines whether an angle of the acceleration in the left-right direction of the vehicle relative to the vehicle traveling direction, which is determined by the output from the acceleration sensor indicative of acceleration in the vehicle left-right direction and the output from the acceleration sensor indicative of acceleration in the vehicle front-rear direction, is greater than a predetermined angle. When the angle of acceleration in the vehicle left-right direction is determined as being greater than the predetermined value, the vehicle collision determination apparatus displaces the determination curve in an upward direction toward the collision region to thereby prevent deployment of the airbag. In the vehicle collision determination apparatus, as for frontal collisions in which the amount of overlap between the vehicle body and a colliding object is small, the output from the acceleration sensor indicative of the acceleration in the vehicle up-down direction becomes large as the amount of overlap between the vehicle body and the colliding object decreases.

In the frontal collisions involving a small overlapping amount between the vehicle body and the colliding object, acceleration in the vehicle left-right direction occurs with a delay from the occurrence of acceleration in a rearward direction of the vehicle. Accordingly if a determination as to whether deployment of the airbag is required were made upon the occurrence of the acceleration in the vehicle left-right direction, an appropriate protection of the occupant by the airbag could not be achieved. At the event of a frontal collision in which the amount of overlap between the vehicle body and a colliding object is small, the vehicle collision determination apparatus shown in JP 07-165004A may determine the collision as a collision requiring deployment of the airbag on the basis of the output from the acceleration sensor indicative of the acceleration in the vehicle front-rear direction. Thus, the prior vehicle collision determination apparatus is not fully satisfactory in determining a collision in which deployment of an airbag is not required.

It is therefore an object of the present invention to provide a vehicle collision determination apparatus which is capable of protecting a vehicle occupant more appropriately. Other objects of the invention will become apparent to a person skilled in the art from the following description of a preferred embodiment taken in conjunction with the accompanying drawings.

### SUMMARY OF THE INVENTION

According to a first aspect of the present invention, there is provided a vehicle collision determination apparatus comprising: a sensor disposed on a mounting surface in a cabin of a vehicle; and a determining part that determines whether or not a collision of the vehicle has occurred, on the basis of an output from the sensor, wherein the output from the sensor includes first acceleration in a direction vertical to the mounting surface, and wherein when energy based on an amplitude of the first acceleration or a physical quantity correlating to the energy exceeds a threshold, the determining part determines that the collision has occurred.

When a collision occurs, an impact inputted to the vehicle causes vibration or acceleration not only in a longitudinal or front-rear direction but also in a vertical or up-down direction of the vehicle. An amplitude of the vibration or acceleration in the up-down direction of the vehicle becomes large as the impact increases. Since the output from the sensor includes the first acceleration in a direction vertical to the mounting surface, if the mounting surface is horizontal, the sensor can output acceleration in the up-down direction of the vehicle and the determining part can accurately determine the occurrence of a collision in which an impact inputted to the vehicle is large.

In one preferred form of the invention, the output of the sensor includes second acceleration in a rearward direction of the vehicle, and when a value, which is determined by the energy or the physical quantity correlating to the energy and an integrated value of the second acceleration, exceeds the threshold, the determining part determines that the collision has occurred.

With this arrangement, since the determining part makes a determination as to whether the collision has occurred by using the integrated value of the second acceleration in the rearward direction of the vehicle in addition to the energy based on the amplitude of the first acceleration or the physical quantity correlating to the energy, the degree of freedom in setting the threshold increases and the occurrence of a collision involving a large impact on the vehicle can be determined with increased accuracy.

Preferably, the determining part further determines whether the collision has occurred by using a first-order integrated value of the second acceleration and a second-order integrated value of the second acceleration, and when both a result of the determination using the first-order integrated value and the second-order integrated value and a result of the determination using the energy or the physical quantity correlating to the energy show that the collision has occurred, the determining part makes a definite decision that the collision has occurred.

With this arrangement, since the determining part makes a definite decision that the collision has occurred when both the result of the determination using the first-order integrated value and the second-order integrated value and the result of the determination using the energy or the physical quantity correlating to the energy show that the collision has occurred, the occurrence of the collision involving a large impact can be more accurately determined.

Preferably, the determining part determines severity of the collision using the energy or the physical quantity correlating to the energy. By thus determining the collision severity, the vehicle collision determination apparatus can operates an occupant protection device with one corresponding protection force selected from among a plurality of protection forces according to the determined collision severity.

It is preferable that the determining part further determines severity of the collision using the energy or the physical quantity correlating to the energy and also determines severity of the collision using the first-order integrated value of the second acceleration and the second-order integrated value of the second acceleration, and when both a result of the severity determination using the energy or the physical quantity correlating to the energy and a result of the severity determination using the first-order integrated value of the second acceleration and the second-order integrated value of the second acceleration show that a severity level of the collision is high, the determining part makes a definite decision that the severity level of the collision is high.

With this arrangement, since the determining part makes a definite decision that severity level of the collision is high when both the result of the severity determination using the first-order integrated value and the second-order integrated value and the result of the severity determination using the energy or the physical quantity correlating to the energy show that the severity level of the collision is high, the collision severity can be accurately determined by using the same collision determination apparatus configured to determine the occurrence of the collision.

According to a second aspect of the present invention, there is provided a vehicle collision determination apparatus comprising: a sensor disposed on a mounting surface in a cabin of a vehicle; and a determining part that determines severity of a collision of the vehicle based on an output from the sensor, wherein the output from the sensor includes first acceleration in a direction vertical to the mounting surface, and wherein when a value, which is determined by energy based on an amplitude of the first acceleration or a physical quantity correlating to the energy, exceeds a threshold, the determining part determines that a severity level of the collision is high.

When a collision occurs, an impact inputted to the vehicle causes vibration or acceleration not only in a longitudinal or front-rear direction but also in a vertical or up-down direction of the vehicle. An amplitude of the vibration or acceleration in the up-down direction of the vehicle becomes large as the impact increases. Since the output from the sensor includes the first acceleration in a direction vertical to the mounting surface, if the mounting surface is horizontal, the sensor can output acceleration in the up-down direction of the vehicle and the determining part can accurately determine the severity of the collision.

In one preferred form of the invention, the output of the sensor includes second acceleration in a rearward direction of the vehicle, and when a value, which is determined by the energy or the physical quantity correlating to the energy and an integrated value of the second acceleration, exceeds the threshold, the determining part determines that the severity level of the collision is high.

With this arrangement, since the determining part determines the collision severity by using the integrated value of the second acceleration in the rearward direction of the vehicle in addition to the energy based on the amplitude of the first acceleration or the physical quantity correlating to the energy, the degree of freedom in setting the threshold increases and the collision severity can be determined with increased accuracy.

It is preferably that the determining part further determines the severity level of the collision using a first-order integrated value of the second acceleration and a second-order integrated value of the second acceleration, and when both a result of the severity determination using the first-order integrated value and the second-order integrated value and a result of the severity determination using the energy or the physical quantity correlating to the energy show that the severity level of the collision is high, the determining part makes a definite decision that the severity level of the collision is high.

With this arrangement, since the determining part makes a definite decision that severity level of the collision is high when both the result of the severity determination using the first-order integrated value and the second-order integrated value and the result of the severity determination using the energy or the physical quantity correlating to the energy show that the severity level of the collision is high, the collision severity can be determined with enhanced accuracy.

Preferably, the determining part, on the basis of the severity of the collision, determines one corresponding restraining force selected from among a plurality of restraining forces, and the one corresponding restraining force is generated while a seatbelt device provided on the vehicle is restraining an occupant upon the occurrence of the collision. With the one corresponding restraining force thus determined according to the collision severity, the seatbelt device can restrain the occupant with an appropriate restraining force.

Preferably, the determining part, on the basis of the severity of the collision, determines one corresponding surface pressure selected from among a plurality of surface pressures, and the one corresponding surface pressure is produced while at least one airbag of an airbag system provided on the vehicle is deploying upon the occurrence of the collision. With the one corresponding surface pressure thus determined according to the collision severity, the airbag system can deploy the airbag in such a manner as to provide the occupant with an appropriate surface pressure.

Preferably, the direction vertical to the mounting surface is an up-down direction of the vehicle. Since the direction vertical to the mounting surface on which the sensor is disposed and the up-down direction of the vehicle are coincident with each other, the determining part can accurately determine the occurrence of a collision and/or the severity of the collision.

### BRIEF DESCRIPTION OF THE DRAWINGS

FIG. 1 is a block diagram showing a configuration of a vehicle collision determination apparatus according to a preferred embodiment of the present invention;

FIG. 2A is a perspective view showing a front part of a vehicle body;

FIG. 2B is a side view of the front part of the vehicle illustrative of an arrangement of a sensor;

FIGS. 3A, 3B and 3C are schematic plan views showing different modes of collision of the vehicle;

FIG. 4A is a graph showing a collision determination map used for determining whether or not a collision requiring operation of an occupant protection device has occurred, on the basis of an output from the sensor indicative of an acceleration in a vertical or up-down direction of the vehicle;

FIG. 4B is a graph showing a collision severity determination map used for determining severity of a collision on the basis of the output from the sensor indicative of the acceleration in the vertical or up-down direction of the vehicle;

FIG. 5A is a graph showing a collision determination map used for determining whether or not a collision requiring operation of the occupant protection device has occurred, on the basis of an output from the sensor indicative of a longitudinal or front-rear direction of the vehicle;

FIG. 5B is a graph showing a collision severity determination map used for determining severity of a collision on the basis of the output from the sensor indicative of the longitudinal or front-rear direction of the vehicle;

FIG. 6A is a graph showing the load acting on a seatbelt that can be changed according to the collision severity; and

FIG. 6B is a time chart showing various examples of the inflator ignition timing for deployment of an airbag.

### DETAILED DESCRIPTION OF THE PREFERRED EMBODIMENT

A preferred structural embodiment of the present invention will be described in detail below, by way of example only, with reference to the accompanying sheets of drawings.

### 1. Structure and Arrangement

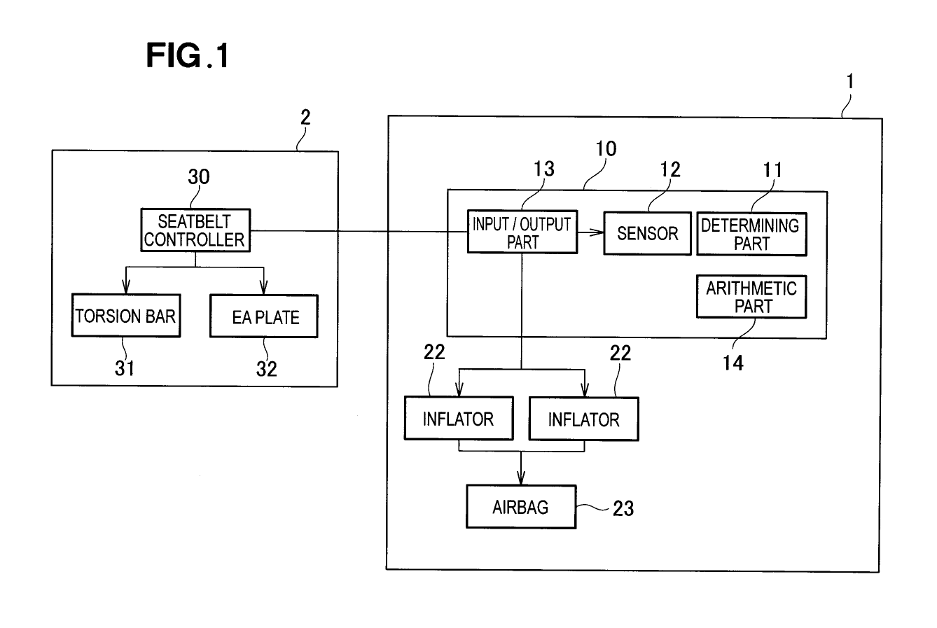

FIG. 1 shows in block diagram a configuration of a vehicle collision determination apparatus 10 according to an embodiment of the present invention. The vehicle collision determination apparatus 10 includes a determining part 11 and a sensor 12. The vehicle collision determination apparatus 10 may further include an input/output part 13, and an arithmetic part 14. Furthermore, the vehicle collision determination apparatus 10 may form a part of an airbag system 1 in which the input/output part 13 outputs a signal to two inflators 22 provided with at least one airbag 23. Additionally, the input/output part 13 may output a signal to a seatbelt controller 30 of a seatbelt device 2 which includes the seatbelt controller 30, a torsion bar 31, and an energy absorbing plate (EA plate) 32. When used in a vehicle equipped with the seatbelt device 2, the collision determination apparatus 10 may operate as an SRS (supplemental restraint system) or an SRS unit. The seatbelt device 2 is configured to change an occupant restraining force according to severity of a collision, by using a mechanism, such as the torsion bar or the EA plate, which is capable of changing the occupant restraining force. A typical example of the occupant-restraining-force-varying mechanism is disclosed in Japanese Patent Application Laid-open Publication (JP-A) No. 2011-79387. The seatbelt device 2 may not be provided with the seatbelt controller 30 in which instance the input/output part 13 of the vehicle collision determination unit (SRS unit) 10 sends a signal directly to the torsion bar 31 and the EA plate 32. The seatbelt device 2 can thus be controlled by the vehicle collision determination apparatus (SRS unit) 10.

An output from the sensor 12 includes first acceleration in a direction vertical to a mounting surface of the sensor 12. The output from the sensor 12 may further include second acceleration in a rearward direction of the vehicle. The first acceleration may be in one direction vertical to the mounting surface (e.g. an upward or downward direction as viewed from the mounting surface), or alternatively in two directions vertical to the mounting surface (e.g. an upward direction and a downward direction as viewed from the mounting surface). Furthermore, the second acceleration may include not only acceleration in the rearward direction of the vehicle but also acceleration in a longitudinal or front-rear direction of the vehicle.

Though not shown, the sensor 12 is constituted by a longitudinal sensor element configured to detect acceleration in the longitudinal or front-rear direction of the vehicle, a vertical sensor element configured to detect acceleration in a direction vertical to the mounting surface of the sensor 12, a CPU (central processing unit), a memory, and an input/output interface. The longitudinal sensor element and the vertical sensor element each detect acceleration in the corresponding direction, and the CPU and the memory operate to calculate first acceleration in a direction vertical to the mounting surface on which the sensor 12 is disposed, and second acceleration in the rearward direction of the vehicle. The thus calculated accelerations are outputted via the input/output interface to the input/output part 13, the determining part 11, or the arithmetic part 14 of the vehicle collision determination apparatus 10. The longitudinal sensor element and the vertical sensor element detect the longitudinal acceleration and the vertical accelerations, respectively. From these accelerations, the sensor 12 is also able to detect vibrations generated due to periodic occurrence of the accelerations. Thus, the sensor 12 can detect not only accelerations but also vibrations.

The sensor 12 may be constituted by the longitudinal sensor element, the vertical sensor element, and the input/output interface. In such instance, the arithmetic part 14 undertakes calculation of the first and second accelerations. As an alternative, the sensor 12 may include the vertical sensor element as a sole sensor element.

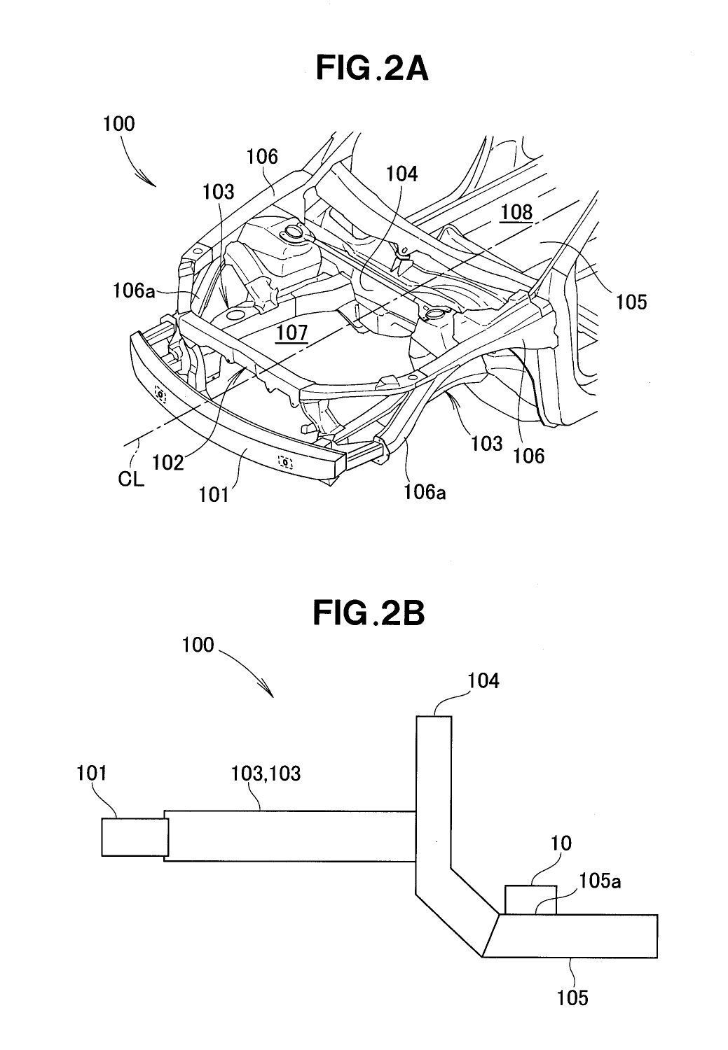

Referring next to FIGS. 2A and 2B, an example of arrangement of the vehicle collision determination apparatus 10 will be described. As shown in FIG. 2A, a front part of the vehicle 100 includes a bumper 101, a bulkhead 102, left and right front side frames 103, 103, left and right upper members 106, 106, a dashboard lower member 104, and a floor 105 that are arranged in the described order as viewed from the front of the vehicle 100. Each of the left and right upper members 106, 106 has a downwardly sloping front end portion 106a. The dashboard lower member 104 partitions an engine room or compartment 107 and a passenger compartment or cabin 108. The cabin 108 is a region provided above the floor 105. The vehicle collision determination apparatus 10 is preferably disposed on a position where vibration or acceleration produced due to an impact transmitted from the bumper 101 through the left and right side frames 103, 103 at the time of a head-on collision in particular can be detected by the vehicle collision determination apparatus 10.

FIG. 2B is a side view showing the front part of the vehicle 100 with the bulkhead 102 and the left and right upper members 106, 106 including their downwardly sloping front end portions 106a, 106a removed for clarity. As shown in FIG. 2B, the vehicle collision determination apparatus 10 is disposed on the floor 105 so that the vibration or acceleration that has been transmitted to the left and right front side frames 103, 103 can be detected at the floor 105 via the dashboard lower member 104. With the vehicle collision determination apparatus 10 thus disposed on the floor 105, the sensor 12 is arranged such that a direction of the sensor 12 which is vertical to the mounting surface 105a is an up-down direction of the vehicle 100. With this arrangement, an output from the sensor 12 includes first acceleration in a vertical or up-down direction of the vehicle 100. In this instance, if the vehicle collision determination apparatus 10 is disposed on a longitudinal centerline CL (FIG. 2A) of the vehicle 100, noise can be suppressed and a head-on collision can be detected with increased accuracy. It will be appreciated that the position of the sensor 12 is automatically determined when the vehicle collision determination apparatus 10 is disposed on the floor 105. As an alternative, the sensor 12 may be provided separately and independently from the vehicle collision determination apparatus 10 and disposed solely on the floor 105. Following is explained under an assumption that the vehicle collision determination apparatus 10 incorporating therein the sensor 12 is disposed on the floor 105 and positioned on the longitudinal centerline CL.

### 2. Collision Determination and Collision Severity Determination

### 2-1. Mode of Collision

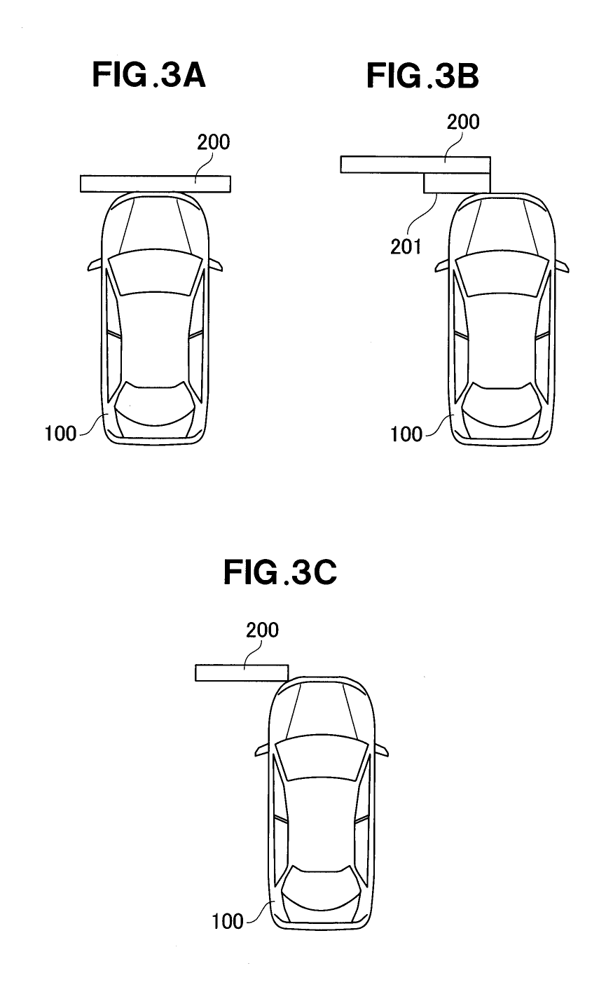

FIG. 3 shows different modes of collision of the vehicle 100. The collision shown in FIG. 3A is a so-called “full-wrap” collision in which the front end of the vehicle 100 is made to collide with a wall or barrier 200 made of a rigid material such as concrete. The collision shown in FIG. 3B is a so-called “offset deformable barrier (ODB)” frontal collision in which the vehicle 100 is made to collide head-on on the driver's side or front passenger's side with an aluminum honeycomb structure 201 attached to the barrier 200. The ODB frontal collision assumes a collision of the own vehicle 100 with another vehicle. The collision shown in FIG. 3C is a so-called “narrow offset” frontal collision in which a left or right end of the front of the vehicle 100 is made to collide with the concrete will or barrier 200. In the narrow offset frontal collision, the amount of overlap between the vehicle front end and the barrier 200 is very small.

In the full-wrap frontal collision shown in FIG. 3A, due to a large amount of overlap between the vehicle front end and the rigid barrier 200, the left and right front side frames 103, 103 are subjected to a large impact force and damages on an occupant are severe. Thus, at the time of this mode of collision, an occupant protection device, such as the airbag system 1 and/or the seatbelt device 2, needs to be operated.

In the ODB frontal collision shown in FIG. 3B, because the honeycomb structure 201 is not rigid at the instant of the collision and because only the left front side frame 103 is subjected to a collision load, an impact inputted to the cabin 108 is smaller than that in the full-wrap frontal collision and damages on an occupant at the time of collision are not severe. Thus, in this mode of collision, the occupant protection device, such as the airbag system 1 and/or the seatbelt device 2 needs not be operated at the instant of the collision, and determination as to whether the occupant protection device is to be operated needs to be made at appropriate timing.

In the narrow offset frontal collision shown in FIG. 3C, the amount of overlap between the vehicle front end and the rigid barrier 200 is very small and only the downwardly sloping front end portion 106a of the left upper member 106 is made to collide with the rigid barrier 200. An impact inputted to the cabin 108 is therefore smaller than that in the full-wrap frontal collision and damages on an occupant at the time of collision is not severe. In this mode of collision, the occupant protection device, such as the airbag system 1 and/or the seatbelt device 2, needs not be operated at the movement when the downwardly sloping front end portion 106a of the left upper member 106 collides with the rigid barrier 200, and determination as to whether the occupant protection device is to be operated needs to be made at appropriate timing.

### 2-2. Collision Determination Method

The determining part 11 of the collision determination apparatus 10 determines that a collision, which requires operation of the occupant protection device, such as the airbag system 1 and/or the seatbelt device 2, has occurred, when energy based on an amplitude of the first acceleration outputted from the sensor 12 or a physical quantity correlating to the energy exceeds a threshold. Here, the energy based on an amplitude of the first acceleration is determined for example by integrating a square value of the amplitude of the first acceleration by means of the arithmetic part 14. The physical quantity correlating to the energy based on the amplitude of the first acceleration is a physical quantity which varies in relation to a change in the energy. For example, the physical quantity is an integrated value of the absolute value of the amplitude of the first acceleration, a value of the n-th power of the energy, or a value equal to the product and/or the sum of the absolute value of an amplitude of acceleration or the energy and n, where n is a constant.

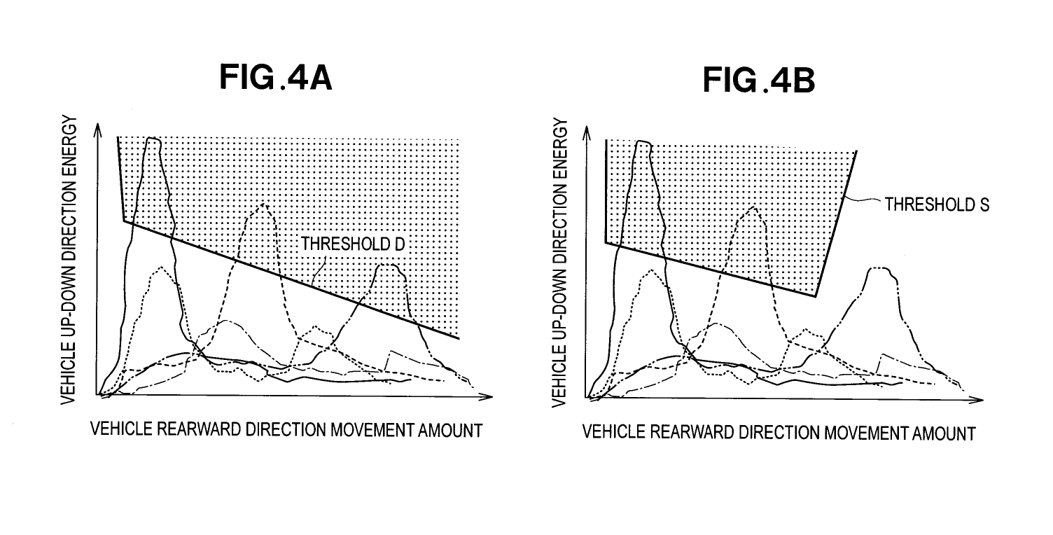

Referring now to FIG. 4A, description will be made about a manner in which energy based on an amplitude of the first acceleration outputted from the sensor 12 is used to determine whether a collision requiring operation of the occupant protection device has occurred. The FIG. 4A shows a collision determination map graphically shown with its horizontal axis representing the vehicle rearward movement amount by way of a second-order integrated value of the second acceleration in the vehicle rearward direction outputted from the sensor 12, and with its vertical axis representing the vehicle up-down direction energy by way of energy based on an amplitude of the first acceleration in the vertical or up-down direction of the vehicle 100. The collision determination map has a device operation threshold (threshold D) which is previously set for discriminating whether operation of the occupant protection device, such as the airbag system 1 and/or the seatbelt device 2 is necessary. The threshold D set on the collision determination map needs not be a constant value, and may rise at an arbitrary position. Thus, the degree of freedom in setting the threshold D is high. When a value determined by an vehicle rearward movement amount and vehicle up-down direction energy at the time of a collision exceeds the threshold D and enters a shaded region (device operating region), the determining part 11 of the vehicle collision determination apparatus 10 determines that a collision requiring operation of the occupant protection device has occurred.

In FIG. 4A, five different modes of collision are shown by five different curves. More specifically, a high-speed full-wrap frontal collision is indicated by a solid line, an intermediate-speed full-wrap frontal collision is indicated by a broken line, a low-speed full-wrap frontal collision is indicated by two-dot chain line, a narrow offset frontal collision is indicated by a dotted line, and an ODB frontal collision is indicated by a dot chain line. Each of the five curves is obtained by plotting values determined by the vehicle rearward movement amounts and the vehicle up-down direction energy at the time of a corresponding one of the five different modes of collision. In the illustrated embodiment shown in FIG. 4A, the high-speed full-wrap frontal collision (solid line), the intermediate-speed full-wrap frontal collision (broken line), and the low-speed full-wrap frontal collision (two-dot chain line) exceed the threshold D and enter the device operating region.

In the high-speed full-wrap frontal collision (solid line), the intermediate-speed full-wrap frontal collision (broken line), and the low-speed full-wrap frontal collision (two-dot chain line), a large impact is inputted to the floor 105 via the left and right front side frames 103, 103. Upon receipt of the impact force, the floor 105 is caused to vibrate not only in the vehicle rearward direction but also in the vehicle up-down direction. The vibration becomes large as the magnitude of the impact increases. In the high-speed full-wrap frontal collision (solid line), the intermediate-speed full-wrap frontal collision (broken line), and the low-speed full-wrap frontal collision (two-dot chain line), a value of the vehicle up-down direction energy which is energy based on an amplitude of the first acceleration in the vehicle up-down direction outputted from the sensor 12 becomes large as compared to those in the narrow offset frontal collision (dotted line) and the ODB collision (dot chain line). Accordingly, by appropriately setting the threshold D, the determining part 11 of the vehicle collision determination apparatus 10 can accurately discriminate between a collision requiring operation of the occupant protection device and a collision not requiring operation of the occupant protection device.

The horizontal axis of the collision determination map shown in FIG. 4A represents the vehicle rearward movement amount which is represented by a second-order integrated value as an integrated value of the second acceleration. The integrated value of the second acceleration may be a first-order integrated value representing the vehicle rearward velocity. As in the case of the collision determination map shown in FIG. 4A, a determination in which the first acceleration selected from among outputs from the sensor 12 is used so as to determine whether a collision requires operation of the occupant protection device, such as the airbag system 1 and/or the seatbelt device 2 is called as a “Z-axis collision determination”. The Z-axis collision determination may be used either singly or alternatively in combination with an X-axis collision determination in which only the second acceleration is used from among the outputs from the sensor 12 so as to determine whether a collision requires operation of the occupant protection device, as will be described later.

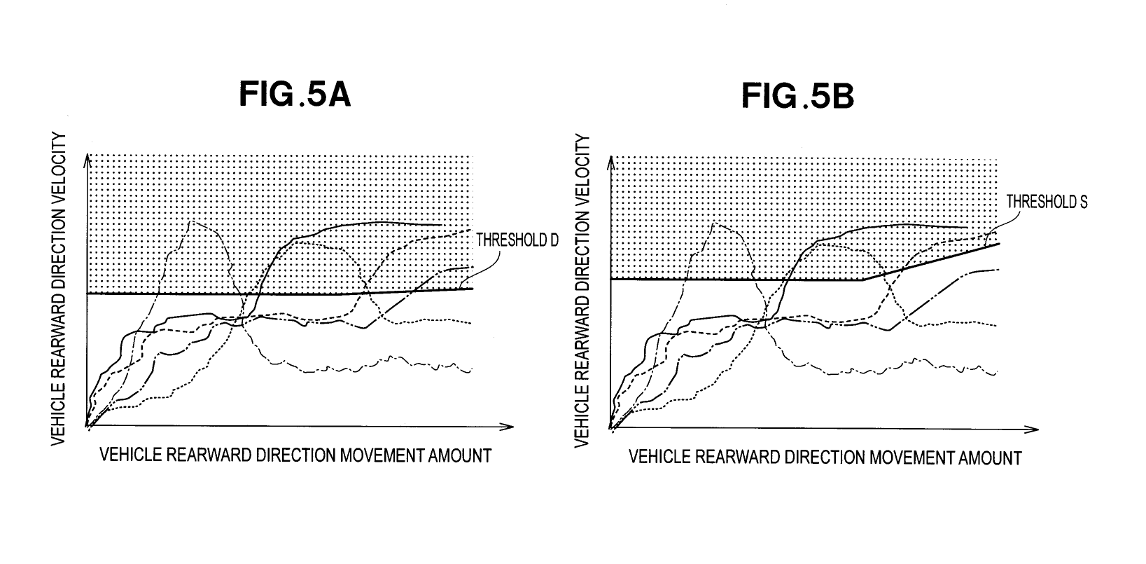

Referring next to FIG. 5A, an example of the X-axis collision determination will be described. FIG. 5A shows a collision determination map graphically shown with its horizontal axis representing the vehicle rearward moving amount by way of a second-order integrated value of the second acceleration in the vehicle rearward direction outputted from the sensor 12, and with its vertical axis representing the vehicle rearward velocity by way of a first-order integrated value of the second acceleration in the vehicle rearward direction. The collision determination map has a device operation threshold (threshold D) which is previously set for discriminating whether operation of the occupant protection device, such as the airbag system 1 and/or the seatbelt device 2, is required. Likewise the threshold D set in conjunction with the Z-axis collision determination, the threshold D set on the collision determination map for the X-axis collision determination needs not be a constant value, and may rise at an arbitrary position. Thus, the degree of freedom in setting the threshold D is high. When a value determined by an vehicle rearward movement amount and the vehicle rearward velocity at the time of a collision exceeds the threshold D and enters a shaded region (device operating region), the determining part 11 of the vehicle collision determination apparatus 10 determines that a collision requiring operation of the occupant protection device has occurred.

In FIG. 5A, five different modes of collision are shown by five different curves, in the same manner as shown in FIG. 4A. More specifically, a high-speed full-wrap frontal collision is indicated by a solid line, an intermediate-speed full-wrap frontal collision is indicated by a broken line, a low-speed full-wrap frontal collision is indicated by two-dot chain line, a narrow offset frontal collision is indicated by a dotted line, and an ODB frontal collision is indicated by a dot chain line. Each of the five curves is obtained by plotting values determined by the vehicle rearward movement amounts and the vehicle rearward velocities. In the illustrated embodiment shown in FIG. 5A, all of the five modes of collision exceed the threshold D and enter the device operating region.

In theory, as previously discussed, an impact inputted to the cabin 108 is smaller in the narrow offset frontal collision (dotted line) and the ODB frontal collision (dot chain line) than in the full-wrap frontal collisions, and damages on an occupant at these types of collision are not severe. Accordingly, in many cases, the narrow offset frontal collision and the ODB frontal collision are not suitable for operating timing of the occupant protection device. However, in the narrow offset frontal collision shown in FIG. 3C, only the downwardly sloping front end portions 106a of the left upper member 106 shown in FIG. 2 is made to collide with the rigid barrier 200, but large acceleration in the vehicle rearward direction is instantaneously generated. As a result, a value decided by the vehicle rearward movement amount and the vehicle rearward direction velocity both based on the second acceleration in the vehicle rearward direction exceeds the threshold D and enters the device operating region. Thus, the determining part 11 of the vehicle collision determination apparatus 10 can recognize the collision to be a severe collision and determines that operation of the occupant protection device in early timing is needed.

For this reason, the X-axis collision determination used singly for determining whether or not a collision requires operation of the occupant protection device is undesirable in that operation of the occupant protection device in inappropriate timing would occur. However, in the Z-axis collision determination, it may occur that when acceleration in the vehicle up-down direction is generated in travelling on a rough road, a value which is determined by the vehicle rearward movement amount and the vehicle up-down direction energy instantaneously exceeds the threshold D and enters the device operating region shown in FIG. 4A. In order to prevent the occupant protection device from being operated under such condition, it is preferable that the X-axis collision determination and the Z-axis collision determination are used in combination so as to determine whether or not a collision requiring operation of the occupant protection device has occurred. It is therefore desirable that only when both the Z-axis collision determination and the X-axis collision determination determine that a collision requiring operation of the occupant protection device has occurred, the determining part 11 makes a definite decision that a collision requiring operation of the occupant protection device has occurred.

Although in the collision determination method described above, energy based on an amplitude of the first acceleration is used, a physical quantity correlating to energy based on an amplitude of the first acceleration can be used in place of the energy based on the amplitude of the first acceleration.

### 2-3. Collision Severity Determination Method

The determining part 11 of the vehicle collision determination apparatus 10 determines that a level of collision severity is high when energy based on an amplitude of the first acceleration outputted from the sensor 12 exceeds a threshold. Based on the thus determined collision severity level, one corresponding protection force selected from among a plurality of protection forces generated by the occupant protection device, such as the airbag system 1 and/or the seatbelt device 2, is determined. The number of collision severity levels may be two levels, i.e., a high level (Hi) and a low level (Lo), or more than three levels. When the collision severity level is determined as being high (Hi), a high protection force is determined from among the plurality of protection forces generated by the occupant protection device, such as the airbag system 1 and/or the seatbelt device 2. The collision severity level will be hereinafter referred to for brevity as “severity”.

Referring next to FIG. 4B, an example of the collision severity determination using energy based on an amplitude of the first acceleration outputted from the sensor 12 will be described. FIG. 4 shows a severity determination map graphically shown with its horizontal axis representing the vehicle rearward movement amount by way of a second-order integrated value of the second acceleration in the vehicle rearward direction outputted from the sensor, and with its vertical axis representing the vehicle up-down direction energy by way of energy based on an amplitude of the first acceleration in the vertical or up-down direction of the vehicle 100. The severity determination map has a severity determination threshold (threshold S) previously set for discriminating whether the severity is high (Hi) or low (Lo) where the number of severity determination levels is two, i.e., a high level (Hi) and a low level (Lo). The threshold S set on the severity determination map needs not be a constant value, and may rise at an arbitrary position in the same manner as the threshold D set on the collision determination map shown in FIG. 4A. Thus, the degree of freedom in setting the threshold S is high. When a value which is determined by an vehicle rearward movement amount and vehicle up-down direction energy at the time of a collision exceeds the threshold S and enters a shaded region (Hi region), the determining part 11 of the vehicle collision determination apparatus 10 determines that the severity is high (Hi). In the case where the number of severity levels is three or more, two or more thresholds S are set for enabling discrimination between three or more regions of different severity levels.

In FIG. 4B, five different modes of collision are shown by five different curves. More specifically, a high-speed full-wrap frontal collision is indicated by a solid line, an intermediate-speed full-wrap frontal collision is indicated by a broken line, a low-speed full-wrap frontal collision is indicated by two-dot chain line, a narrow offset frontal collision is indicated by a dotted line, and an ODB frontal collision is indicated by a dot chain line. Each of the five curves is obtained by plotting values determined by the vehicle rearward movement amounts and the vehicle up-down direction energy at the time of a corresponding one of the five different modes of collision. In the illustrated embodiment shown in FIG. 4B, the high-speed full-wrap frontal collision (solid line), the intermediate-speed full-wrap frontal collision (broken line), and the low-speed full-wrap frontal collision (two-dot chain line) exceed the threshold D and enter the device operating region. The five curves shown in FIG. 4B trace the same paths as those described on the collision determination map shown in FIG. 4A. It is possible according to the invention that the curves shown on the collision determination map of FIG. 4A and the curved shown on the severity determination map of FIG. 4B are made to trace different paths by an arbitrary arithmetic operation performed for a different integration period or section. In the example shown in FIG. 4B, two modes of collision, i.e., the high-speed full-wrap frontal collision (solid line) and the intermediate-speed full-wrap frontal collision (broken line) exceed the threshold S and enter the high (Hi) region.

Likewise the Z-axis collision determination described above, values of the vehicle up-down direction energy involved in the high-speed full-wrap frontal collision (solid line), the intermediate-speed full-wrap frontal collision (broken line), and the low-speed full-wrap frontal collision (two-dot chain line) are larger than those involved in the narrow offset frontal collision (dotted line) and the ODB frontal collision (dot chain line). It is therefore readily possible to set the threshold S such that the high-speed full-wrap frontal collision (solid line) and the intermediate-speed full-wrap frontal collision (broken line) enter the Hi region, and the remaining collisions belong to the Lo region. By thus setting the threshold S, the determining part 11 of the vehicle collision determination apparatus 10 can accurately determine the severity. Among those collisions which are determined as requiring operation of the occupant protection device, the low-speed full-wrap frontal collision (two-dot chain line) determined as belonging to the low (Lo) severity has a rate or speed of 26 km/h, for example.

The horizontal axis of the severity determination map shown in FIG. 4B uses the vehicle rearward direction movement amount which is represented by a second-order integrated value as an integrated value of the second acceleration. However, likewise the horizontal axis of the collision determination map shown in FIG. 4A, the vehicle rearward velocity represented by a first-order integrated value can be used. As in the severity determination map shown in FIG. 4B, a determination of the severity performed by using the first acceleration selected from among a plurality of outputs of the sensor 12 will be referred to as a “Z-axis severity determination”. The Z-axis severity determination may be used either singly or alternatively in combination with an X-axis severity determination performed by using only the second acceleration, as will be described later.

Referring next to FIG. 5B, the X-axis severity determination will be described. FIG. 5B shows a severity determination map graphically shown with its horizontal axis representing the vehicle rearward movement amount by way of a second-order integrated value of the second acceleration in the vehicle rearward direction outputted from the sensor 12, and with its vertical axis representing the vehicle rearward direction velocity as a first-order integrated value. The severity determination map has a severity determination threshold (threshold S) previously set for discriminating whether the severity is high (Hi) or low (Lo) where the number of severity determination levels is two, i.e., a high level (Hi) and a low level (Lo). In the X-axis severity determination, the threshold S set on the severity determination map needs not be a constant value, and may rise at an arbitrary position in a like manner as the threshold S set for the Z-axis severity determination. Thus, the degree of freedom in setting the threshold S is high. When a value which is determined by a vehicle rearward movement amount and vehicle rearward direction velocity at the time of a collision exceeds the threshold S and enters a shaded region (Hi region), the determining part 11 of the vehicle collision determination apparatus 10 determines that the severity is high (Hi). Likewise the Z-axis severity determination, if the number of severity levels set in the X-axis severity determination is three or more, two or more thresholds S will be set for enabling discrimination between three or more regions of different severity levels.

In FIG. 5B, five different modes of collision are shown by five different curves. More specifically, a high-speed full-wrap frontal collision is indicated by a solid line, an intermediate-speed full-wrap frontal collision is indicated by a broken line, a low-speed full-wrap frontal collision is indicated by two-dot chain line, a narrow offset frontal collision is indicated by a dotted line, and an ODB frontal collision is indicated by a dot chain line. The five curves shown in FIG. 5B trace the same paths as those described on the collision determination map shown in FIG. 5A. It is possible according to the invention that the curves shown on the collision determination map of FIG. 5A and the curved shown on the severity determination map of FIG. 5B are made to trace different paths by an arbitrary arithmetic operation performed for a different integration period In the example shown in FIG. 5B, four modes of collision excluding the low-speed full-wrap frontal collision (two-dot chain line) exceed the threshold S and enter the high (Hi) region.

In theory, as previously discussed, it is desirable that severities of the narrow offset frontal collision (dotted line) and the ODB frontal collision (dot chain line) are determined as being low because in these collisions, an impact inputted to the cabin 108 and damages that may occur on an occupant are small as compared to those in the full-wrap frontal collisions. However, in the narrow offset frontal collision shown in FIG. 3C, only the downwardly sloping front end portions 106a of the left upper member 106 shown in FIG. 2 is made to collide with the rigid barrier 200, but large acceleration in the vehicle rearward direction is instantaneously generated. As a result, a value which is decided by the vehicle rearward movement amount and the vehicle rearward direction velocity both based on the second acceleration in the vehicle rearward direction exceeds the threshold S and enters the device operating region. Thus, the determining part 11 of the vehicle collision determination apparatus 10 can determine that the severity is high.

For this reason, the X-axis severity determination used singly for determining the severity is undesirable in that one corresponding adequate protection force selected from among a plurality of protection forces produced by the occupant protection device cannot be determined. However, in the Z-axis severity determination, it may occur that when acceleration in the vehicle up-down direction is generated in travelling on a rough road, a value which is determined by the vehicle rearward movement amount and the vehicle up-down direction energy instantaneously exceeds the threshold S and enters the high region (device operating region) shown in FIG. 4B. In order to prevent the occupant protection device from being operated under such condition, it is desirable that the X-axis severity determination and the Z-axis severity determination are used in combination to determine the collision severity. It is therefore desirable that only when both a result of the Z-axis severity determination and a result of the X-axis severity determination determine show that the severity is high, the determining part 11 makes a definite decision that the severity is high.

In the collision severity determination method described above, energy based on an amplitude of the first acceleration is used. However, a physical quantity correlating to energy based on an amplitude of the first acceleration can be used in place of the energy based on the amplitude of the first acceleration, as in the same manner as the collision determination method previously described.

### 3. Operation

Description will be next made about operations of the airbag system 1 equipped with the vehicle collision determination apparatus 10 and the seatbelt device 2 at the event of a collision. When the determining part 11 of the vehicle collision determination apparatus 10 determines that a collision requiring operation of the occupant protection device has occurred, a pretensioner operating signal and an airbag operating signal are outputted from the input/output part 13 of the vehicle collision determination apparatus 10.

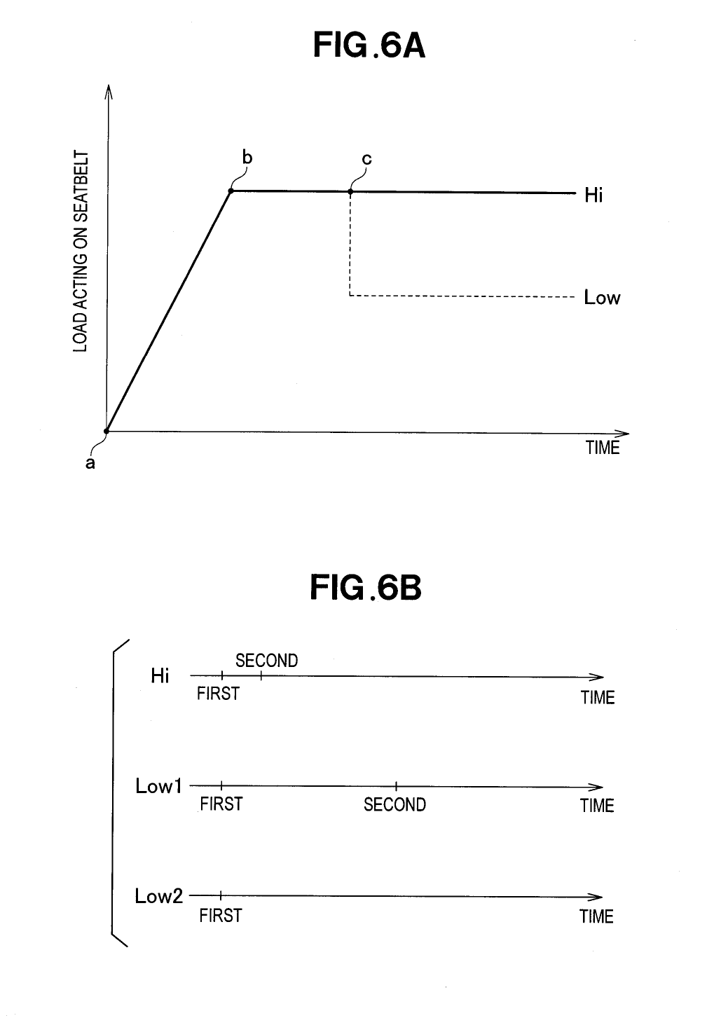

Upon receipt of the pretensioner operating signal, the seatbelt controller 30 of the seatbelt device 2 operates a pretensioner (not shown) to rotate a spool (not shown) in a direction to retract a webbing (not shown) to thereby restrain the occupant. After operation of the pretensioner, the torsion bar 31 is locked at one end thereof, and the EA plate 32 is operated, so that a load acting on the seatbelt increases up to a load set for the torsion bar 31 and the EA plate 32, as indicated by a line segment extending from a point “a” to a point “b” shown in FIG. 6A. When the load acting on the seatbelt exceeds the load set for the torsion bar 31 and the EA plate 32, the load acting on the seatbelt is maintained at a constant value by twisting of the torsion bar 31 and energy absorption by the EA plate 32, as indicated by a line segment extending from the point “b” to a point “c” shown in FIG. 6A.

Here, when the determining part 11 determines that a collision requiring operation of the occupant protection device has occurred, and severity of the collision is high, the seatbelt controller 30 keeps the torsion bar 31 and the EA plate 32 in an operating state in order to restrain the occupant with a high binding force (restraining force). On the other hand, when the determining part 11 fails to determine, in a fixed amount of time (for example, in 5 milliseconds after a first ignition timing of at least one inflator 22), that the severity is high, the severity is determined as being low. When the severity is low, the occupant is restrained by a lower binding force (restraining force) than in the high severity case. To this end, the seatbelt controller 30 stops operation of the EA plate 32 and continues operation of the torsion bar 31 so as to absorb the load on the seatbelt. When the torsion bar is operating, the load acting on the seatbelt is kept in a constant value which is smaller than a value of the load acting on the seatbelt when both the torsion bar 31 and the EA plate 32 are operating. As indicated by a dotted line shown in FIG. 6A, the load acting on the seatbelt in the case of low severity determination is kept constant at a lower value than the value (at a point “c”) in the high severity determination.

When the airbag operating signal is outputted, at least one inflator 22 of the airbag system 1 is ignited to thereby deploy at least one airbag. In this instance, when the determining part 11 determines that a collision requiring operation of the occupant protection device has occurred and the severity is high, two inflators 22 are ignited, as indicated by a timing chart Hi shown in FIG. 6B. More specifically, one of the two inflators 22 shown in FIG. 1 is ignite at first ignition timing, and the other inflator 22 is ignited at second ignition timing. When the severity is high, a time lug between the first ignition timing and the second ignition timing is 5 milliseconds, for example. When the severity is high, the two inflators 22 are ignited at substantially the same time so that a surface pressure provided by the at least one airbag 23 at the time of deployment is set to a high value.

On the other hand, when the determining part 11 fails to determine, in a fixed amount of time (for example, in 5 milliseconds after the first ignition timing) that the severity is high, the severity is determined as being low, and two inflators 22 or only one of the two inflators 22 is ignited at ignition timing shown in a timing chart Low1 or Low2 shown in FIG. 6B. When the two inflators 22 are ignited according to the timing chart Low1, one of the two inflators 22 shown in FIG. 1 is ignited at first ignition timing, and the other inflator 22 is ignited at second ignition timing. In this instance, a time lug between the first ignition timing and the second ignition timing is 40 milliseconds, for example. Alternatively, when only one inflator 22 is ignited according to the timing chart Low2, one of the inflators 22 shown in FIG. 1 is ignited at first ignition timing shown in the timing chart Low2. When the severity is low, two inflators 22 are ignited with a fixed time interval, or alternatively, only one inflator 22 is ignited, so that a surface pressure provided by the at least one airbag 23 at the time of deployment is set to be lower than that in the high severity determination case. According to the ignition timing shown in the timing chart Low1 of FIG. 6B, the deployment time period of the at least one airbag 23 is set to be longer than that in the timing chart Low 2.

It will be appreciated from the foregoing description that the determining part 11 needs to make a determination as to whether the severity is high or not before the inflator 22 is ignited at the second ignition timing according to the timing chart Hi shown in FIG. 6B. It is therefore necessary for the threshold S to be set on the severity determination map in order to enable the determining part 11 to make a determination as to whether the severity is high or not before a time period of 5 milliseconds from the first ignition of the inflator is elapsed after the occurrence of a collision.

In the embodiment described above, the integrated value may be a section integrated value, that is an integrated value obtained through definite integration for a prescribed period, such as a very short time (for example, 10 milliseconds), or alternatively an all-sections integrated value, that is an integrated value obtained through definite integration for a period from a collision start time to the current time).

### 4. Modifications

In the embodiment described above, a single sensor 12 provided on the floor 105 outputs first acceleration in a vertical or up-down direction of the vehicle 100 and second acceleration in a rearward direction of the vehicle 100. It is possible according to the invention to further provide a second sensor and output second acceleration using the second sensor. In the latter case, the second sensor may be provided, as a front sensor, on a forward side of the bulkhead 102 and positioned on the longitudinal centerline CL of the vehicle 100.

Obviously, various minor changes and modifications of the present invention are possible in the light of the above teaching. It is therefore to be understood that within the scope of the appended claims the invention may be practiced otherwise than as specifically described.

What is claimed is:

1. A vehicle collision determination apparatus comprising:
a sensor disposed on a mounting surface in a cabin of a vehicle; and
a determining part configured to determine whether or not a collision of the vehicle has occurred, on the basis of an output from the sensor,
wherein the output from the sensor includes first acceleration in a direction vertical to the mounting surface, and
wherein when energy based on an amplitude of the first acceleration or a physical quantity correlating to the energy exceeds a threshold, the determining part determines that the collision has occurred.

2. The vehicle collision determination apparatus according to claim 1, wherein the output of the sensor includes second acceleration in a rearward direction of the vehicle, and
when a value, which is determined by the energy or the physical quantity correlating to the energy and an integrated value of the second acceleration, exceeds the threshold, the determining part determines that the collision has occurred.

3. The vehicle collision determination apparatus according to claim 2, wherein the determining part further determines whether the collision has occurred by using a first-order integrated value of the second acceleration and a second-order integrated value of the second acceleration, and
when both a result of the determination using the first-order integrated value and the second-order integrated value and a result of the determination using the energy or the physical quantity correlating to the energy show that the collision has occurred, the determining part makes a definite decision that the collision has occurred.

4. The vehicle collision determination apparatus according to claim 1, wherein the determining part determines severity of the collision using the energy or the physical quantity correlating to the energy.

5. The vehicle collision determination apparatus according to claim 3, wherein the determining part further determines severity of the collision using the energy or the physical quantity correlating to the energy and also determines severity of the collision using the first-order integrated value of the second acceleration and the second-order integrated value of the second acceleration, and
when both a result of the severity determination using the energy or the physical quantity correlating to the energy and a result of the severity determination using the first-order integrated value of the second acceleration and the second-order integrated value of the second acceleration show that a severity level of the collision is high, the determining part makes a definite decision that the severity level of the collision is high.

6. A vehicle collision determination apparatus comprising:
a sensor disposed on a mounting surface in a cabin of a vehicle; and
a determining part that determines severity of a collision of the vehicle based on an output from the sensor,
wherein the output from the sensor includes first acceleration in a direction vertical to the mounting surface, and
wherein when a value, which is determined by energy based on an amplitude of the first acceleration or a physical quantity correlating to the energy, exceeds a threshold, the determining part determines that a severity level of the collision is high.

7. The vehicle collision determination apparatus according to claim 6, wherein the output of the sensor includes second acceleration in a rearward direction of the vehicle, and
when a value, which is determined by the energy or the physical quantity correlating to the energy and an integrated value of the second acceleration, exceeds the threshold, the determining part determines that the severity level of the collision is high.

8. The vehicle collision determination apparatus according to claim 7, wherein the determining part further determines the severity level of the collision using a first-order integrated value of the second acceleration and a second-order integrated value of the second acceleration, and
when both a result of the severity determination using the first-order integrated value and the second-order integrated value and a result of the severity determination using the energy or the physical quantity correlating to the energy show that the severity level of the collision is high, the determining part makes a definite decision that the severity level of the collision is high.

9. The vehicle collision determination apparatus according to claim 4, wherein the determining part, on the basis of the severity of the collision, determines one corresponding restraining force selected from among a plurality of restraining forces, and the one corresponding restraining force is generated while a seatbelt device provided on the vehicle is restraining an occupant upon the occurrence of the collision.

10. The vehicle collision determination apparatus according to claim 4, wherein the determining part, on the basis of the severity of the collision, determines one corresponding surface pressure selected from among a plurality of surface pressures, and the one corresponding surface pressure is produced while at least one airbag of an airbag system provided on the vehicle is deploying upon the occurrence of the collision.

11. The vehicle collision determination apparatus according to claim 9, wherein the determining part, on the basis of the severity of the collision, determines one corresponding surface pressure selected from among a plurality of surface pressures, and the one corresponding surface pressure is produced while at least one airbag of an airbag system provided on the vehicle is deploying upon the occurrence of the collision.

12. The vehicle collision determination apparatus according to claim 5, wherein the determining part, on the basis of the severity of the collision, determines one corresponding restraining force selected from among a plurality of restraining forces, and the one corresponding restraining force is generated while a seatbelt device provided on the vehicle is restraining an occupant upon the occurrence of the collision.

13. The vehicle collision determination apparatus according to claim 5, wherein the determining part, on the basis of the severity of the collision, determines one corresponding surface pressure selected from among a plurality of surface pressures, and the one corresponding surface pressure is produced while at least one airbag of an airbag system provided on the vehicle is deploying upon the occurrence of the collision.

14. The vehicle collision determination apparatus according to claim 12, wherein the determining part, on the basis of the severity of the collision, determines one corresponding surface pressure selected from among a plurality of surface pressures, and the one corresponding surface pressure is produced while at least one airbag of an airbag system provided on the vehicle is deploying upon the occurrence of the collision.

15. The vehicle collision determination apparatus according to claim 6, wherein the determining part, on the basis of the severity of the collision, determines one corresponding restraining force selected from among a plurality of restraining forces, and the one corresponding restraining force is generated while a seatbelt device provided on the vehicle is restraining an occupant upon the occurrence of the collision.

16. The vehicle collision determination apparatus according to claim 6, wherein the determining part, on the basis of the severity of the collision, determines one corresponding surface pressure selected from among a plurality of surface pressures, and the one corresponding surface pressure is produced while at least one airbag of an airbag system provided on the vehicle is deploying upon the occurrence of the collision.

17. The vehicle collision determination apparatus according to claim 15, wherein the determining part, on the basis of the severity of the collision, determines one corresponding surface pressure selected from among a plurality of surface pressures, and the one corresponding surface pressure is produced while at least one airbag of an airbag system provided on the vehicle is deploying upon the occurrence of the collision.

18. The vehicle collision determination apparatus according to claim 1, wherein the direction vertical to the mounting surface is an up-down direction of the vehicle.
